(19) United States
(12) Patent Application Publication
(10) Pub. No.: US 2015/0271060 A1
(43) Pub. Date: Sep. 24, 2015

(54) COMMUNICATION APPARATUS INCLUDING A PLURALITY OF NETWORK INTERFACES, METHOD OF CONTROLLING COMMUNICATION APPARATUS, AND STORAGE MEDIUM

(71) Applicant: CANON KABUSHIKI KAISHA, Tokyo (JP)

(72) Inventor: Norihisa Kishimoto, Kawasaki-shi (JP)

(21) Appl. No.: 14/661,517

(22) Filed: Mar. 18, 2015

(30) Foreign Application Priority Data
Mar. 24, 2014 (JP) 2014-059833

(51) Int. Cl. H04L 12/707; H04L 29/12; H04L 12/741

(52) U.S. Cl. CPC H04L 45/22; H04L 45/745; H04L 61/6068; H04L 61/6086

(57) ABSTRACT

A communication apparatus including a plurality of network interfaces capable of retransmitting data immediately after failure in data. It is determined whether there is a network interface having an IP address in the same subnet as a destination IP address in the network interfaces. Data transmission is performed using a default network interface if it is determined that there is no network interface having an IP address in the same subnet as the destination IP address in the network interfaces. If it is determined that there is no network interface having an IP address in the same subnet as the destination IP address in the network interfaces and where the data transmission using the default network interface has failed, the data transmission is performed again by changing the used network interface from the default network interface to another network interface.

### BACKGROUND OF THE INVENTION

1. Field of the Invention

The present invention relates to a communication apparatus including a plurality of network interfaces, a method of controlling the communication apparatus, and a storage medium.

2. Description of the Related Art

In recent years, a plurality of network interface cards (hereinafter referred to as “NICs”) have been installed in devices, such as an image forming apparatus and a personal computer, such that the network interface cards can be simultaneously used by connecting them to a network.

Accordingly, by installing in a device at least two NICs, e.g. in a combination of a wired NIC and a wired NIC, a wired NIC and a wireless NIC, or a wireless NIC and a wireless NIC, and connecting these NICs to the same network or different networks, respectively, there are envisaged more flexible and more diverse methods of use of the device.

In a device including such NICs, transmission of data to a communication partner sometimes fails due to network environments to which the NICs are connected, respectively.

To deliver data to a communication partner as reliably as possible in the event of occurrence of failure of data transmission, there has been disclosed a technique of causing e.g. a router having a plurality of NICs installed therein to store data transmission of which has failed and time at which the data is scheduled to be retransmitted, and causing the same data to be retransmitted after the lapse of a predetermined time period (see e.g. Japanese Patent Laid-Open Publication No. H03-96041).

However, the technique disclosed in Japanese Patent Laid-Open Publication No. H03-96041 suffers from a problem that data cannot be retransmitted immediately after the failure in the transmission thereof since the data is retransmitted after the lapse of the predetermined time period.

### SUMMARY OF THE INVENTION

The present invention provides a communication apparatus including a plurality of network interfaces which are capable of retransmitting data immediately after failure in the transmission thereof, a method of controlling the communication apparatus, and a storage medium.

In a first aspect of the present invention, there is provided a communication apparatus that includes a plurality of network interfaces, one of the plurality of network interfaces being set as a default network interface, comprising a determination unit configured to determine whether or not there is a network interface having an IP address in the same subnet as a destination IP address in the plurality of network interfaces, a transmission unit configured to perform data transmission using the default network interface, in a case where it is determined by the determination unit that there is no network interface having an IP address in the same subnet as the destination IP address in the plurality of network interfaces, and a retransmission unit configured to perform the data transmission again by changing the used network interface from the default network interface to another network interface, in a case where it is determined by the determination unit that there is no network interface having an IP address in the same subnet as the destination IP address in the plurality of network interfaces and also where the data transmission using the default network interface has failed.

In a second aspect of the present invention, there is provided a communication apparatus that includes a plurality of network interfaces, one of the plurality of network interfaces being set as a default network interface, comprising a determination unit configured to determine whether or not a destination address is an IPv6 link-local address, a transmission unit configured to perform data transmission using the default network interface, in a case where it is determined by the determination unit that the destination address is an IPv6 link-local address, and a retransmission unit configured to perform the data transmission again by changing the used network interface from the default network interface to another network interface, in a case where it is determined by the determination unit that the destination address is an IPv6 link-local address and also where the data transmission using the default network interface has failed.

In a third aspect of the present invention, there is provided a communication apparatus that includes a plurality of network interfaces, comprising a determination unit configured to determine whether or not there is a network interface having an IP address in the same subnet as a destination IP address in the plurality of network interfaces, a selection unit configured to select a network interface for use in performing data transmission from the plurality of network interfaces, in a case where it is determined by the determination unit that there is no network interface having an IP address in the same subnet as the destination IP address in the plurality of network interfaces, a transmission unit configured to perform data transmission using the network interface selected by the selection unit, and a retransmission unit configured to perform the data transmission again by changing the used network interface from the network interface selected by the selection unit to another network interface, in a case where it is determined by the determination unit that there is no network interface having an IP address in the same subnet as the destination IP address in the plurality of network interfaces and also where the data transmission executed by the transmission unit has failed.

In a fourth aspect of the present invention, there is provided a method of controlling a communication apparatus that includes a plurality of network interfaces, one of the plurality of network interfaces being set as a default network interface, comprising determining whether or not there is a network interface having an IP address in the same subnet as a destination IP address in the plurality of network interfaces, performing data transmission using the default network interface, in a case where it is determined by said determining that there is no network interface having an IP address in the same subnet as the destination IP address in the plurality of network interfaces, and performing the data transmission again by changing the used network interface from the default network interface to another network interface, in a case where it is determined by said determining that there is no network interface having an IP address in the same subnet as the destination IP address in the plurality of network interfaces and also where the data transmission using the default network interface has failed.

In a fifth aspect of the present invention, there is provided a method of controlling a communication apparatus that includes a plurality of network interfaces, one of the plurality of network interfaces being set as a default network interface, comprising determining whether or not a destination address is an IPv6 link-local address, performing data transmission using the default network interface, in a case where it is determined by said determining that the destination address is an IPv6 link-local address, and performing the data transmission again by changing the used network interface from the default network interface to another network interface, in a case where it is determined by said determining that the destination address is an IPv6 link-local address and also where the data transmission using the default network interface has failed.

In a sixth aspect of the present invention, there is provided a method of controlling a communication apparatus that includes a plurality of network interfaces, comprising determining whether or not there is a network interface having an IP address in the same subnet as a destination IP address in the plurality of network interfaces, selecting a network interface for use in performing data transmission from the plurality of network interfaces, in a case where it is determined by said determining that there is no network interface having an IP address in the same subnet as the destination IP address in the plurality of network interfaces, performing data transmission using the network interface selected by said selecting, and performing the data transmission again by changing the network interface selected by said selecting to another network interface, in a case where it is determined by said determining that there is no network interface having an IP address in the same subnet as the destination IP address in the plurality of network interfaces and also where the data transmission has failed.

In a seventh aspect of the present invention, there is provided a non-transitory computer-readable storage medium storing a computer-executable program for executing a method of controlling a communication apparatus that includes a plurality of network interfaces, one of the plurality of network interfaces being set as a default network interface, wherein the method comprises determining whether or not there is a network interface having an IP address in the same subnet as a destination IP address in the plurality of network interfaces, performing data transmission using the default network interface, in a case where it is determined by said determining that there is no network interface having an IP address in the same subnet as the destination IP address in the plurality of network interfaces, and performing the data transmission again by changing the used network interface from the default network interface to another network interface, in a case where it is determined by said determining that there is no network interface having an IP address in the same subnet as the destination IP address in the plurality of network interfaces and also where the data transmission using the default network interface has failed.

In an eighth aspect of the present invention, there is provided a non-transitory computer-readable storage medium storing a computer-executable program for executing a method of controlling a communication apparatus that includes a plurality of network interfaces, one of the plurality of network interfaces being set as a default network interface, wherein the method comprises determining whether or not a destination address is an IPv6 link-local address, performing data transmission using the default network interface, in a case where it is determined by said determining that the destination address is an IPv6 link-local address, and performing the data transmission again by changing the used network interface from the default network interface to another network interface, in a case where it is determined by said determining that the destination address is an IPv6 link-local address and also where the data transmission using the default network interface has failed.

In a ninth aspect of the present invention, there is provided a non-transitory computer-readable storage medium storing a computer-executable program for executing a method of controlling a communication apparatus that includes a plurality of network interfaces, wherein the method comprises determining whether or not there is a network interface having an IP address in the same subnet as a destination IP address in the plurality of network interfaces, selecting a network interface for use in performing data transmission from the plurality of network interfaces, in a case where it is determined by said determining that there is no network interface having an IP address in the same subnet as the destination IP address in the plurality of network interfaces, performing data transmission using the network interface selected by said selecting, and performing the data transmission again by changing the network interface selected by said selecting to another network interface, in a case where it is determined by said determining that there is no network interface having an IP address in the same subnet as the destination IP address in the plurality of network interfaces and also where the data transmission has failed.

According to the present invention, in a case where data is transmitted via a network interface selected from a plurality of network interfaces and the transmission of the data fails, the data is transmitted via a network interface different from the selected network interface. Therefore, it is possible to retransmit the data immediately after failure in the transmission of the data.

Further features of the present invention will become apparent from the following description of exemplary embodiments (with reference to the attached drawings).

### BRIEF DESCRIPTION OF THE DRAWINGS

FIG. 1 is a schematic diagram of a communication system including an image forming apparatus as a communication apparatus according to an embodiment of the present invention.

FIG. 2 is a schematic diagram of the image forming apparatus appearing in FIG. 1.

FIG. 3 is a schematic diagram of the software configuration of the image forming apparatus appearing in FIG. 1.

FIG. 4 is a diagram of a table set by a NIC-setting section appearing in FIG. 3.

FIG. 5A is a flowchart of a transmission process performed by a CPU appearing in FIG. 2.

FIG. 5B is a continuation of FIG. 5A.

FIG. 6A is a flowchart of a selection process performed in a step in FIG. 5A.

FIG. 6B is a continuation of FIG. 6A.

FIGS. 7A and 7B are flowcharts of respective variations of part of FIG. 5B.

FIG. 8 is a diagram of a screen displayed when a user deletes contents of the FIG. 4 table.

### DESCRIPTION OF THE EMBODIMENTS

The present invention will now be described in detail below with reference to the accompanying drawings showing embodiments thereof.

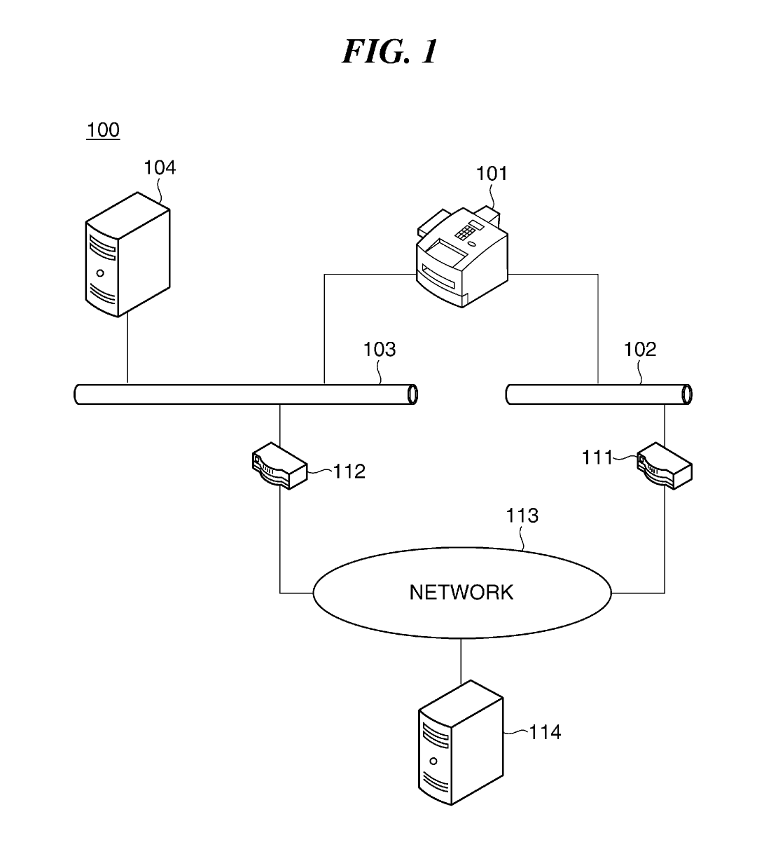

FIG. 1 is a schematic diagram of a communication system 100 including an image forming apparatus 101 as a communication apparatus according to an embodiment of the present invention.

Referring to FIG. 1, the communication system 100 is comprised of the image forming apparatus 101, routers 111 and 112, servers 104 and 114, LANs 102 and 103, and a network 113.

The image forming apparatus 101 includes a plurality of (two, in the present embodiment) interfaces (hereinafter referred to as the “NICs”) for connecting to the LANs 102 and 103, and a general network, such as the network 113. One of the NICs is connected to the LAN 102, and the other NIC is connected to the LAN 103.

The server 104 is connected to the LAN 103. Further, the server 114 is connected to the network 113.

The router 111 is connected to the LAN 102 and the network 113, and the router 112 is connected to the LAN 103 and the network 113.

The network 113 may be a LAN different from the LANs 102 and 103, or may be the Internet.

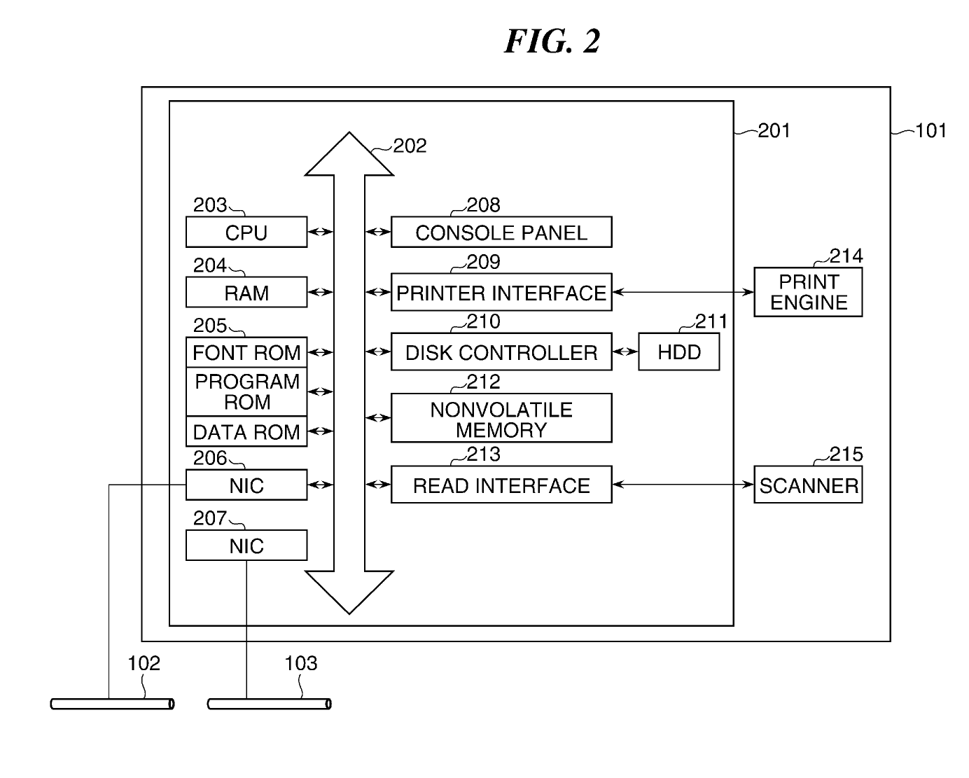

FIG. 2 is a schematic diagram of the image forming apparatus 101 appearing in FIG. 1.

Referring to FIG. 2, the image forming apparatus 101 is comprised of a controller 201, a print engine 214, and a scanner 215.

The controller 201 controls the overall operation of the image forming apparatus 101. The print engine 214 prints an image on a recording medium, such as a sheet, under the control of the controller 201. The scanner 215 reads an original and generates image data of the original under the control of the controller 201.

Further, the controller 201 is comprised of a CPU 203, a RAM 204, a ROM 205, the NICs 206 and 207, a console panel 208, a printer interface 209, a disk controller 210, an HDD 211, a nonvolatile memory 212, and a read interface 213, which are connected to each other by a system bus 202, except for the HDD 211.

The CPU 203 controls the controller 201 to thereby control the overall operation of the image forming apparatus 101. The RAM 204 is used as a work area for the CPU 203, and stores various programs, data, and so forth.

The ROM 205 stores fonts, various programs, data, and so forth. The NIC 206 is connected to the LAN 102, and the NIC 207 is connected to the LAN 103.

The console panel 208 displays various information for a user, and accepts an operation input by the user. The printer interface 209 provides interface between the controller 201 and the print engine 214.

The disk controller 210 controls the HDD 211. The HDD 211 stores e.g. various programs and data. A flowchart, described hereinafter, represents a process which is performed by the CPU 203 through execution of a program which is stored in the HDD 211 or the ROM 205 and is loaded into the RAM 204.

The nonvolatile memory 212 stores information on various settings set by the user via the console panel 208. The read interface 213 provides interface between the controller 201 and the scanner 215.

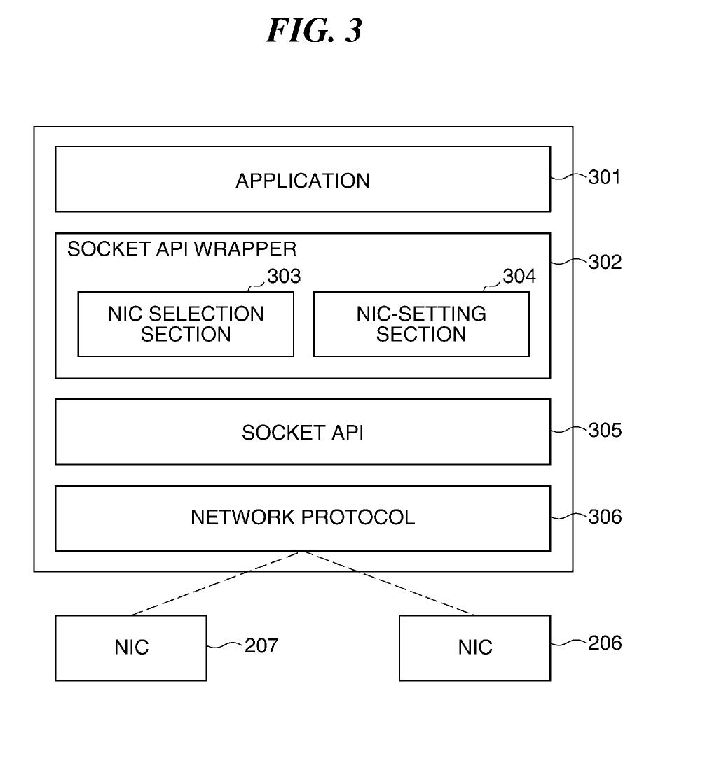

FIG. 3 is a schematic diagram of the software configuration of the image forming apparatus 101 appearing in FIG. 1.

An application 301 has a function of transmitting data to other apparatuses. When the application 301 desires data transmission, a socket API (Application Programming Interface) wrapper 302 is called to thereby call a socket API 305, and data is transmitted from the NIC 207 or 206 via a network protocol 306 of an OS (operating system).

In the present embodiment, it is assumed that the network protocol 306 uses the NIC 206 as a default NIC. Further, in a case where a default router is set, the router 111 is set as the default router.

When the socket API wrapper 302 detects a failure of data transmission from one of the NICs, the socket API wrapper 302 retransmits the same data from the other of the same. When the retransmission is successful, the socket API wrapper 302 causes a NIC-setting section 304 to set at least a pair of destination information and a NIC which has successfully performed the transmission, in a table. This table will be described hereinafter.

When performing data transmission, a NIC selection section 303 searches the table for the pair set by the NIC-setting section 304. When the set pair held in the table is found, i.e. retrieved, the NIC selection section 303 calls the socket API 305 by designating the NIC of the found pair as a transmission source NIC.

Even when data transmission fails once, this makes it possible to select an appropriate NIC from the beginning and transmit data using the NIC next time on.

Although in the present embodiment, the NIC selection section 303 and the NIC-setting section 304 are included in the socket API wrapper 302, in actuality, they may be provided at any suitable location or may be independently provided. Alternatively, they may be included in the application 301 or the socket API 305.

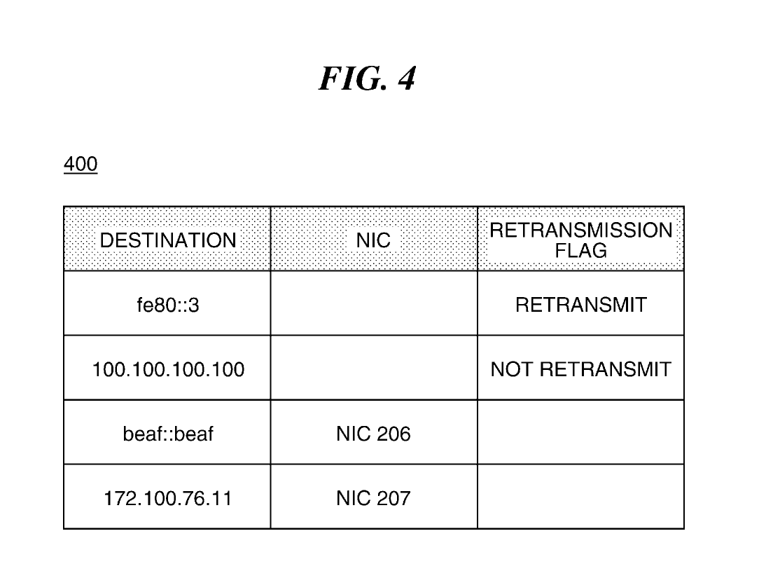

FIG. 4 is a diagram of a transmission management table 400 set by the NIC-setting section 304 appearing in FIG. 3.

The transmission management table 400 appearing in FIG. 4 is stored in the HDD 211.

Referring to FIG. 4, the transmission management table 400 is comprised of destinations, NICs, and retransmission flags. When data transmission from one NIC has failed but data transmission from the other NIC is successful, information indicative of a pair of a destination of the successful transmission and the NIC which has successfully performed the transmission is set in the transmission management table 400. In the following description, to set the information indicative of the pair of the destination of the successful transmission and the NIC which has successfully performed the transmission is simply expressed as “to set the pair of the destination and the NIC”.

In the case of FIG. 4, a pair of “beaf::beaf” and “NIC 206”, and a pair of “172.100.76.11” and “NIC 207” indicate pairs which have successfully performed data transmission.

In addition to the pairs which have successfully performed data transmission as described above, information on data transmission being executed is also set in the transmission management table 400. The retransmission flag as the information indicates whether or not to retransmit data from the other NIC when data transmission from the one NIC has failed.

FIG. 4 shows a case where data transmission to “fe80::3” and data transmission to “100.100.100.100” are being performed, and if the data transmission to “fe80::3” fails, the data is to be retransmitted, whereas if the data transmission to “100.100.100.100” fails, the data is not to be retransmitted.

Further, in a case where data transmission from one NIC fails and retransmission from the other NIC is successful, the other NIC which has successfully performed the retransmission is set in the transmission management table 400 and the retransmission flag is deleted.

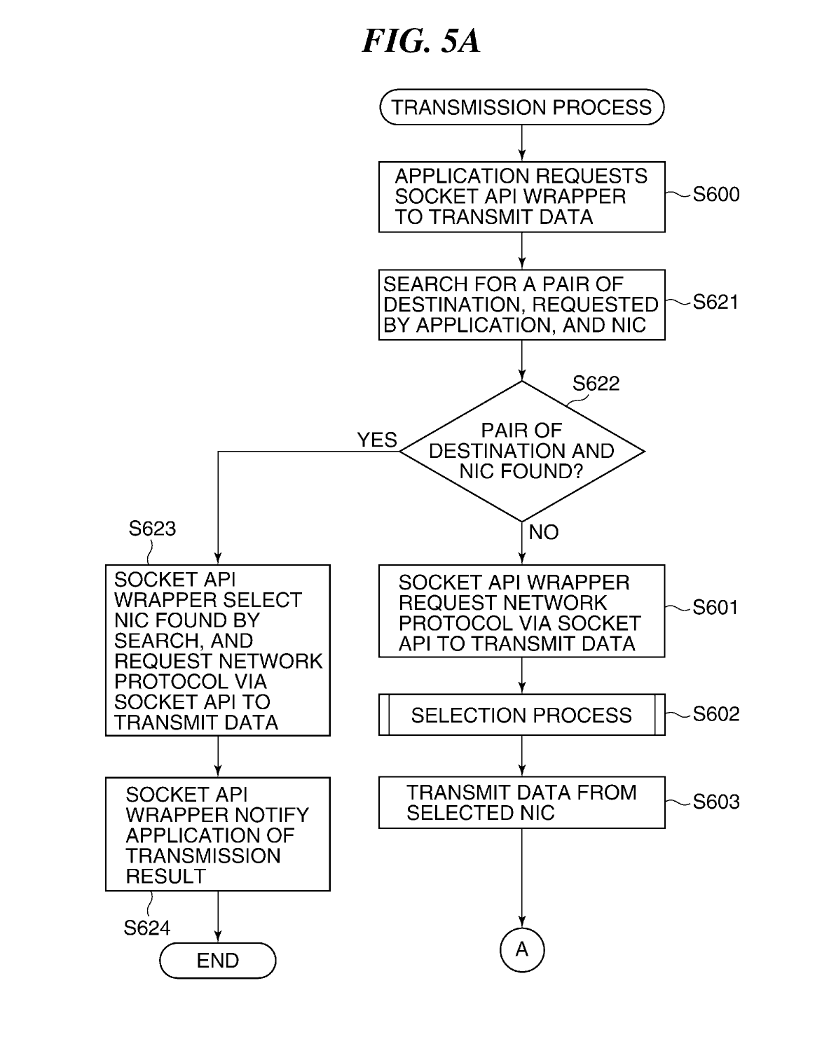

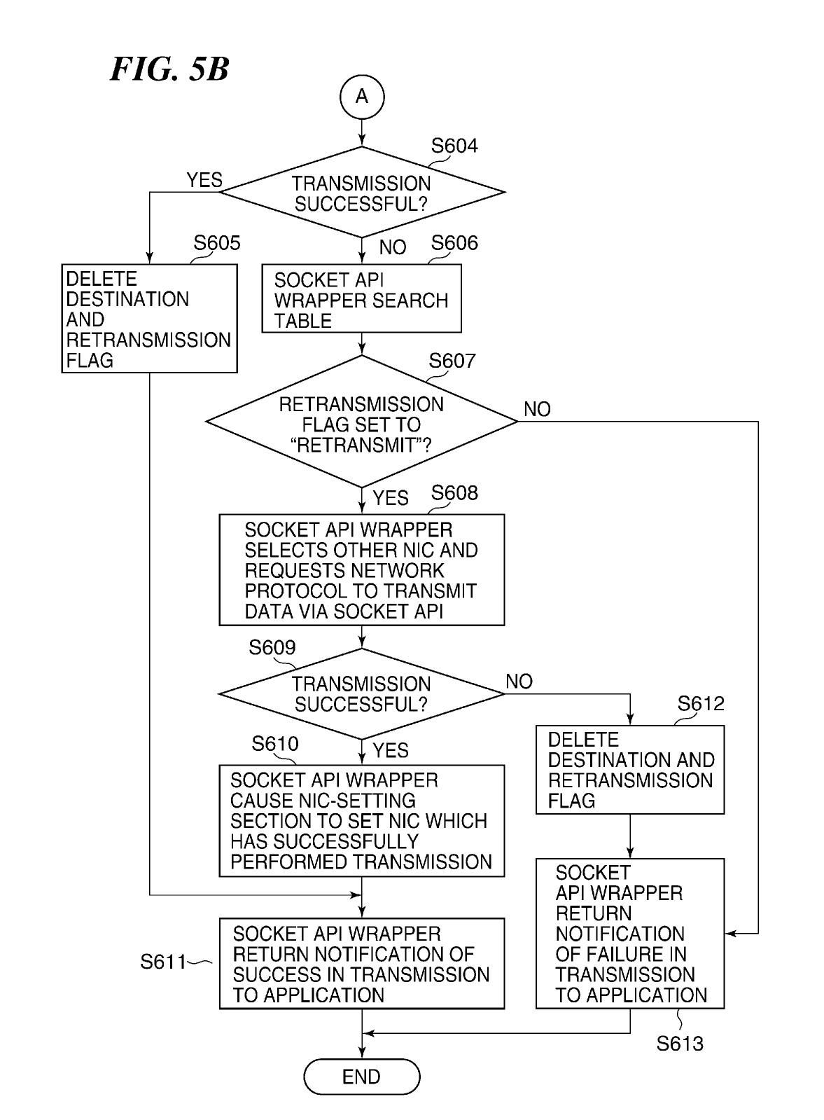

FIGS. 5A and 5B are flowcharts of a transmission process performed by the CPU 203 appearing in FIG. 2.

Referring to FIG. 5A, when the application 301 requests the socket API wrapper 302 to transmit data (step S600), the NIC selection section 303 searches, based on a destination to which the data is to be transmitted, the transmission management table 400 for a pair of the destination to which the data is requested to be transmitted, by the application 301, and a NIC (step S621), and determines whether or not the pair of the destination and the NIC has been found i.e. retrieved (step S622).

If it is determined in the step S622 that the pair of the destination and the NIC has been found i.e. retrieved (YES to the step S622), the socket API wrapper 302 selects the NIC of the found pair, and requests the network protocol 306 via the socket API 305 to transmit the data (step S623). Thus, in the present embodiment, when a destination to which data is to be transmitted is set in advance, an interface that forms a pair with the destination is selected.

Next, the socket API wrapper 302 notifies the application 301 of a result of transmission of the data (step S624), followed by terminating the present process.

On the other hand, if it is determined in the step S622 that the pair of the destination and the NIC has not been found i.e. has not been retrieved (NO to the step S622), the socket API wrapper 302 requests the network protocol 306 via the socket API 305 to transmit the data (step S601).

When requested to transmit the data, the network protocol 306 performs a selection process, described hereinafter (step S602). The selection process corresponds to the operation of a selection unit configured to select from two interfaces an interface for use in transmitting data to a destination via the network, and further, by the selection process, a destination and a retransmission flag are set in the transmission management table 400.

Next, the network protocol 306 transmits the data to the destination from a NIC selected in the selection process (step S603). This step S603 corresponds to the operation of a transmission unit configured to transmit data from a selected NIC.

Then, the process proceeds to a step S604 in FIG. 5B, wherein it is determined whether or not the transmission is successful. If it is determined in the step S604 that the transmission is successful (YES to the step S604), the network protocol 306 deletes the destination and the retransmission flag from the transmission management table 400 (step S605).

Then, the socket API wrapper 302 returns a notification of success in the transmission to the application 301 (step S611), followed by terminating the present process.

On the other hand, if it is determined in the step S604 that the transmission is not successful (NO to the step S604), the socket API wrapper 302 refers to the transmission management table 400 (step S606), and determines whether or not the retransmission flag is set to “retransmit” (step S607).

If it is determined in the step S607 that the retransmission flag is not set to “retransmit” (NO to the step S607), the socket API wrapper 302 returns a notification of a transmission error to the application 301 (step S613), followed by terminating the present process.

On the other hand, if it is determined in the step S607 that the retransmission flag is set to “retransmit” (YES to step S607), the socket API wrapper 302 selects a NIC different from the NIC used for the transmission, and requests the network protocol 306 to transmit the data, via the socket API 305, again (step S608). This step S608 corresponds to the operation of a retransmission unit configured to transmit the data from an interface different from the selected interface.

Then, the socket API wrapper 302 determines whether or not the transmission is successful (step S609). If it is determined in the step S609 that the transmission is successful (YES to the step S609), the socket API wrapper 302 causes the NIC-setting section 304 to set the NIC which has successfully performed the retransmission (step S610), in the transmission management table 400, and the process proceeds to the above-described step S611. Since the destination is set in advance, by setting the NIC in the step S610, when the retransmission is successful, a pair of the destination and the interface, which have successfully performed the transmission, are set in the transmission management table 400.

On the other hand, if it is determined in the step S609 that the transmission is not successful (NO to the step S609), the socket API wrapper 302 deletes the destination and the retransmission flag from the transmission management table 400 (step S612), and proceeds to the above-mentioned step S613.

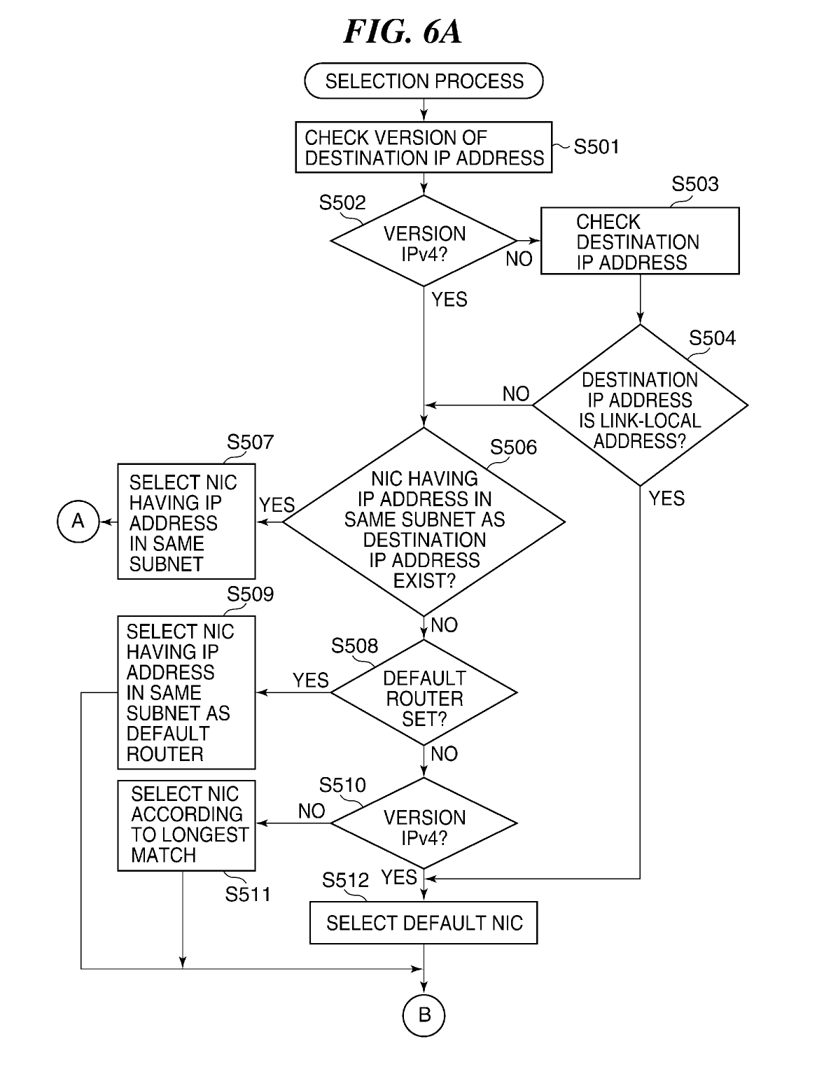

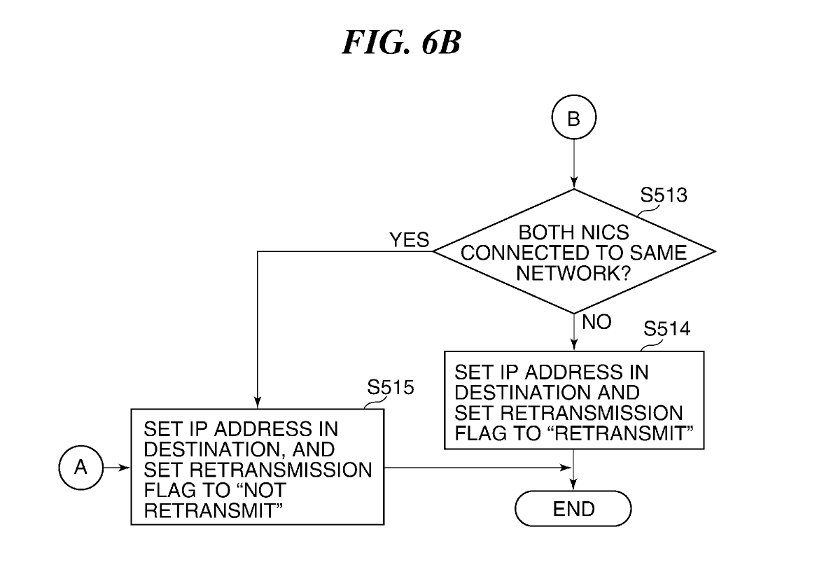

FIGS. 6A and 6B are a flowchart of the selection process performed in the step S602 in FIG. 5A.

Referring to FIGS. 6A and 6B, the network protocol 306 checks a version (IPv4 or IPv6) of an IP address of the destination (step S501), and determines whether or not the version is IPv4 (step S502). This step S502 corresponds to the operation of a version determining unit configured to determine whether or not a version of a destination address, which is the destination IP address, is IPv4.

If it is determined in the step S502 that the version is IPv4 (YES to the step S502), the network protocol 306 determines whether or not there is a NIC that has an IP address in the same subnet as the destination IP address (step S506). This step S506 corresponds to the operation of a subnet determination unit configured to determine whether or not there is a NIC that has the same subnet IP address as the destination address.

If it is determined in the step S506 that there is a NIC that has an IP address in the same subnet as the destination IP address (YES to the step S506), the network protocol 306 selects the NIC that has an IP address in the same subnet as the destination IP address (step S507). Note that when both the NICs 206 and 207 have IP addresses in the same subnet, the NIC 206, which is default, is selected. Thus, in the present embodiment, if it is determined that there is a NIC that has an IP address in the same subnet as the destination IP address, the interface is selected.

Then, the network protocol 306 sets the IP address in the column of “destination” of the transmission management table 400, and sets the retransmission flag to “not retransmit” (step S515), followed by terminating the present process. The reason why the retransmission flag is set to “not retransmit” is that there is no possibility of success in data transmission from the other NICs since the optimum NIC is selected.

Referring again to the step S506, if it is determined that there is no NIC that has an IP address in the same subnet as the destination IP address (NO to the step S506), the network protocol 306 determines whether or not a default router is set (step S508). This step S508 corresponds to the operation of a router determination unit configured to determine whether or not there is a router set in advance.

If it is determined in the step S508 that a default router is set (YES to the step S508), the network protocol 306 selects a NIC that has an IP address in the same subnet as the IP address of the default router 111 (step S509). Thus, in the present embodiment, if it is determined that there is a router set in advance, the network protocol 306 selects a NIC that has an IP address in the same subnet as the IP address of the router set in advance.

Then, the network protocol 306 determines whether or not both of the NICs are connected to the same network (step S513).

If it is determined in the step S513 that both of the NICs are connected to the same network (YES to the step S513), the network protocol 306 sets the IP address in the column of “destination” of the transmission management table 400, and sets the retransmission flag to “not retransmit” (step S515), followed by terminating the present process. The reason why the retransmission flag is set to “not retransmit” is that there is no possibility of success in data transmission from the other NICs connected to the same network when data transmission via the selected NIC has fails.

On the other hand, if it is determined in the step S513 that both the NICs are not connected to the same network (NO to the step S513), the network protocol 306 sets the IP address in the column of “destination” of the transmission management table 400, and sets the retransmission flag to “retransmit” (step S514), followed by terminating the present process.

Referring again to the step S508, if it is determined that no default router is set (NO to the step S508), the network protocol 306 determines whether or not the version is IPv4 (step S510). This step S510 corresponds to the operation of another version determining unit configured to determine whether or not the version of the destination address is IPv4.

If it is determined in the step S510 that the version is not IPv4 but IPv6 (NO to step S510), the network protocol 306 selects a NIC according to longest match (step S511), and proceeds to the above-described step 513. Thus, in the present embodiment, if it is determined that the version of the destination address is not IPv4 but IPv6, a NIC is selected according to longest match.

On the other hand, if it is determined in the step S510 that the version is IPv4 (YES to step S510), the network protocol 306 selects the NIC 206, which is default, (step S512), and proceeds to the above-described step S513. Thus, in the present embodiment, if it is determined that the version of the destination address is IPv4, a predetermined interface advance is selected.

Referring again to the step S502, if it is determined that the version is not IPv4 but IPv6 (NO to step S502), the network protocol 306 checks the destination IP address (step S503), and determines whether or not the IP address is a link-local address (step S504). This step S504 corresponds to the operation of a link-local determination unit configured to determine whether or not the destination address is a link-local address.

If it is determined in the step S504 that the IP address is not a link-local address (NO to the step S504), the network protocol 306 proceeds to the above-described step S506.

On the other hand, if it is determined in the step S504 that the IP address is a link-local address (YES to the step S504), the network protocol 306 proceeds to the above-described step S512. Thus, in the present embodiment, if it is determined that the destination address is a link-local address, a predetermined interface is selected.

Although the selection process described above is a process performed by the network protocol 306, the selection process may be performed by the socket API wrapper 302 or the socket API 305.

In the above-described transmission process, as an example of a case where after failure of data transmission from the selected NIC, data transmission from a different NIC than the selected NIC is successful (YES to the step S609), there may be mentioned a case where the network of the communication system 100 shown in FIG. 1 is constructed using only IPv6 link-local addresses, and all of the NICs 206 and 207 and the server 104 have only IPv6 link-local addresses.

In this case, although the default NIC 206 connected to the LAN 102 is selected according to the determination in the step S504, the server 104 as an actual communication partner is connected to the LAN 103.

Therefore, although data transmission from the NIC 206 always fails, data transmission from the NIC 207 becomes successful.

Further, as another example, there may be mentioned a case where the network of the communication system 100 shown in FIG. 1 is constructed using IPv4 addresses, and some network trouble has occurred between the default router 111 and the server 114 as a communication partner.

In such a case, although data transmission from the NIC 206 selected in the step S509 fails, data transmission from the NIC 207 becomes successful.

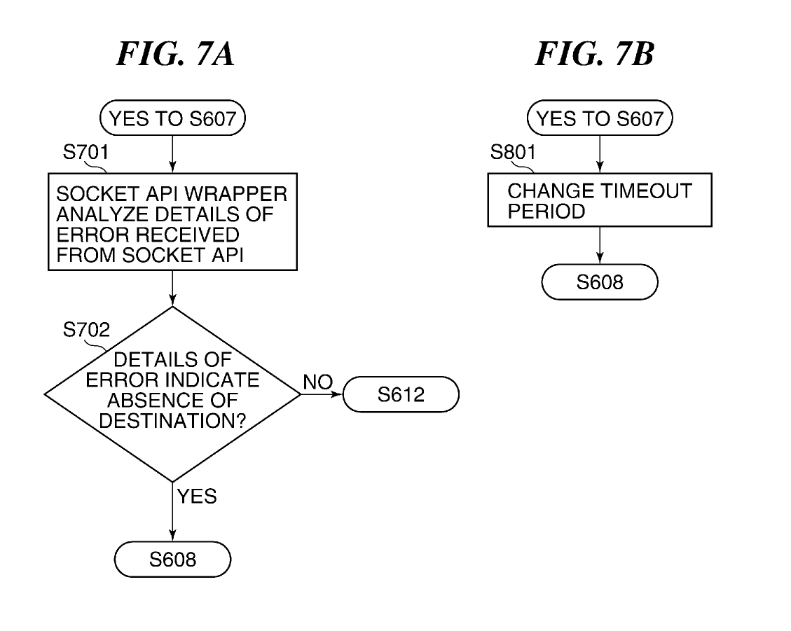

FIGS. 7A and 7B are flowcharts of respective variations of part of FIG. 5B.

FIG. 7A is a flowchart of a process performed for changing an operation by checking a cause of a failure occurring at the time of the first transmission.

Referring to FIG. 7A, if it is determined in the step S607 in FIG. 5B that the retransmission flag is set to “retransmit” (YES to step S607), the socket API wrapper 302 analyzes details of an error received from the socket API 305 (step S701).

The socket API wrapper 302 determines, based on results of the analysis, whether or not the details of the error indicate absence of the destination (step S702). If it is determined in the step S702 that the details of the error indicate absence of the destination (YES to the step S702), the socket API wrapper 302 proceeds to the step S608.

On the other hand, if it is determined in the step S702 that the details of the error do not indicate absence of the destination (NO to the step S702), the socket API wrapper 302 proceeds to the step S612. Then, the socket API wrapper 302 returns the notification of the transmission error in the step S613. Thus, in the present embodiment, when transmission of the data fails, if error details indicative of details of the failure indicate absence of the destination, retransmission of the data is not performed.

In a case where a standard API, such as Linux (registered trademark), is used, examples of errors received from the socket API 305 include ENETUNREACH indicating that the data cannot reach the destination, and ETIMEDOUT indicating that timeout has occurred in spite of an attempt to connect to the destination. In a case where a notification of any of such errors is returned, it is possible to regard that there is no communicability between the destination and the transmission source via the network, and hence the data is determined to be retransmitted using a NIC other than the one already used.

When a notification of an error other than ENETUNREACH and ETIMEDOUT is returned, it is considered that although there is a communicability between the destination and the transmission source via the network, the communication is cut off by the communication partner or some internal error has occurred, so that retransmission of the data is not performed.

Note that the case of ETIMEDOUT being returned includes the following example: In the communication system 100 shown in FIG. 1, when the image forming apparatus 101 desires to communicate with the server 104 using the IPv6 link-local address, the image forming apparatus 101 transmits the data to the LAN 102 first.

When the image forming apparatus 101 transmits the data to the LAN 102, since there is no device for responding to the data, timeout occurs due to the lapse of a predetermined time period. At this time, the socket API 305 returns ETIMEDOUT to the socket API wrapper 302.

The case of ENETUNREACH being returned includes the following case: When the image forming apparatus 101 communicates with the server 114 using the IPv4 address, the router 111 of the LAN 102 detects that the server 114 cannot be reached via the network 113. At this time, the router 111 transmits ENETUNREACH to the image forming apparatus 101.

FIG. 7B is a flowchart of a process performed for changing a timeout period when the data is retransmitted.

Referring to FIG. 7B, if it is determined in the step S607 in FIG. 5B that the retransmission flag is set to “retransmit” (YES to step S607), the socket API wrapper 302 changes the timeout period (step S801), and proceeds to the step S608.

In the step S801, the timeout period is changed to a time period shorter than a timeout period set at the time of the first transmission. This is because assuming that a timeout period at the time of retransmission is made equal to the timeout period at the time of the first transmission, if the retransmission fails, the length of time before the timeout is doubled.

Note that if the timeout period at the time of the first transmission and the timeout period at the time of the retransmission are each set to half the default timeout period, the sum of the timeout period at the time of the first transmission and that at the time of the retransmission becomes equal to the default timeout period. Therefore, the process shown in FIG. 7B may be replaced by a process in which the timeout period at the time of the first transmission and that at the time of the retransmission are adjusted to half the default timeout period.

Thus, in the present embodiment, when transmission of data has failed and retransmission of the data is performed, the timeout period used for determining whether or not data transmission has failed is changed.

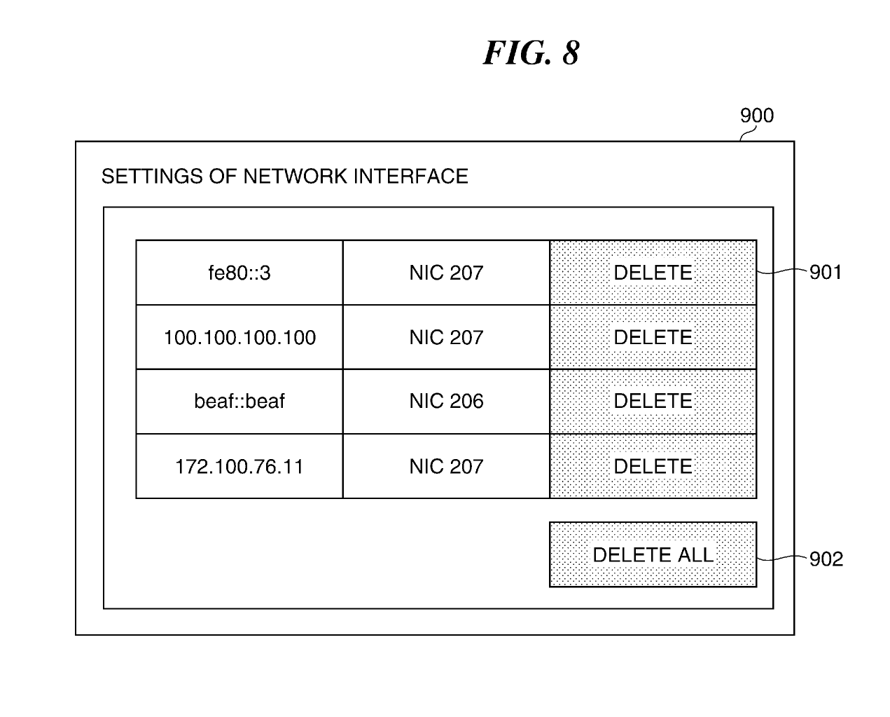

FIG. 8 is a diagram of a screen 900 displayed when the user deletes contents of the transmission management table 400 shown in FIG. 4.

As shown in FIG. 8, pairs of destinations and NICs set in the transmission management table 400 are displayed on the screen 900.

The user can delete the pairs of destinations and NICs set in the transmission management table 400, one by one or all at a time using delete an associated one of buttons 901 and 902. Thus, in the present embodiment, the pairs of destinations and the above-described interfaces set in the transmission management table 400 can be deleted by the user.

The reason for providing the screen 900 is that by changing a network environment or repairing a network environment in which a trouble has occurred, it is sometimes becomes possible to perform communication using a NIC with which communication cannot be originally performed.

As described hereinabove, in a case where a pair of a destination and a NIC are set in a special circumstance, such as before a change of the network environment or during occurrence of a trouble, the user can delete the pair of the destination and the NIC on the screen 900. This makes it possible to perform network communication according to as natural determination as possible by the network protocol.

As described heretofore, according to the present embodiment, data is transmitted from a selected interface (step S603), and if the data transmission has failed (NO to the step S604), the data is transmitted from an interface different from the selected one (step S608), so that it is possible to retransmit the data immediately after the failure of the data transmission.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-059833 filed Mar. 24, 2014 which is hereby incorporated by reference herein in its entirety.

What is claimed is:

1. A communication apparatus that includes a plurality of network interfaces, one of the plurality of network interfaces being set as a default network interface, comprising:
a determination unit configured to determine whether or not there is a network interface having an IP address in the same subnet as a destination IP address in the plurality of network interfaces;
a transmission unit configured to perform data transmission using the default network interface, in a case where it is determined by said determination unit that there is no network interface having an IP address in the same subnet as the destination IP address in the plurality of network interfaces; and
a retransmission unit configured to perform the data transmission again by changing the used network interface from the default network interface to another network interface, in a case where it is determined by said determination unit that there is no network interface having an IP address in the same subnet as the destination IP address in the plurality of network interfaces and also where the data transmission using the default network interface has failed.

2. The communication apparatus according to claim 1, wherein in a case where it is determined by said determination unit that there is a network interface having an IP address in the same subnet as the destination IP address in the plurality of network interfaces, said transmission unit performs data transmission using the network interface having an IP address in the same subnet as the destination IP address, and
wherein in a case where it is determined by said determination unit that there is a network interface having an IP address in the same subnet as the destination IP address in the plurality of network interfaces and also where the data transmission has failed, said retransmission unit terminates the data retransmission as an error without changing the used network interface.

3. A communication apparatus that includes a plurality of network interfaces, one of the plurality of network interfaces being set as a default network interface, comprising:
a determination unit configured to determine whether or not a destination address is an IPv6 link-local address;
a transmission unit configured to perform data transmission using the default network interface, in a case where it is determined by said determination unit that the destination address is an IPv6 link-local address; and
a retransmission unit configured to perform the data transmission again by changing the used network interface from the default network interface to another network interface, in a case where it is determined by said determination unit that the destination address is an IPv6 link-local address and also where the data transmission using the default network interface has failed.

4. A communication apparatus that includes a plurality of network interfaces, comprising:
a determination unit configured to determine whether or not there is a network interface having an IP address in the same subnet as a destination IP address in the plurality of network interfaces;
a selection unit configured to select a network interface for use in performing data transmission from the plurality of network interfaces, in a case where it is determined by said determination unit that there is no network interface having an IP address in the same subnet as the destination IP address in the plurality of network interfaces;
a transmission unit configured to perform data transmission using the network interface selected by said selection unit; and
a retransmission unit configured to perform the data transmission again by changing the used network interface from the network interface selected by said selection unit to another network interface, in a case where it is determined by said determination unit that there is no network interface having an IP address in the same subnet as the destination IP address in the plurality of network interfaces and also where the data transmission executed by said transmission unit has failed.

5. The communication apparatus according to claim 4, wherein in a case where it is determined by said determination unit that there is a network interface having an IP address in the same subnet as the destination IP address in the plurality of network interfaces, said transmission unit performs data transmission using the network interface having an IP address in the same subnet as the destination IP address, and
wherein in a case where it is determined by said determination unit that there is a network interface having an IP address in the same subnet as the destination IP address in the plurality of network interfaces and also where the data transmission has failed, said retransmission unit terminates the data retransmission as an error without changing the used network interface.

6. The communication apparatus according to claim 4, wherein one of the plurality of network interfaces is set as a default network interface in the communication apparatus, and
wherein in a case where it is determined by said determination unit that there is no network interface having an IP address in the same subnet as the destination IP address in the plurality of network interfaces, said selection unit selects the default network interface as a network interface for use in performing data transmission.

7. The communication apparatus according to claim 4, wherein a default router is set in the communication apparatus, and
wherein in a case where it is determined by said determination unit that there is no network interface having an IP address in the same subnet as the destination IP address in the plurality of network interfaces, said selection unit selects a network interface having an IP address in the same subnet as the default router.

8. A method of controlling a communication apparatus that includes a plurality of network interfaces, one of the plurality of network interfaces being set as a default network interface, comprising:
determining whether or not there is a network interface having an IP address in the same subnet as a destination IP address in the plurality of network interfaces;
performing data transmission using the default network interface, in a case where it is determined by said determining that there is no network interface having an IP address in the same subnet as the destination IP address in the plurality of network interfaces; and
performing the data transmission again by changing the used network interface from the default network interface to another network interface, in a case where it is determined by said determining that there is no network interface having an IP address in the same subnet as the destination IP address in the plurality of network interfaces and also where the data transmission using the default network interface has failed.

9. A method of controlling a communication apparatus that includes a plurality of network interfaces, one of the plurality of network interfaces being set as a default network interface, comprising:
determining whether or not a destination address is an IPv6 link-local address;
performing data transmission using the default network interface, in a case where it is determined by said determining that the destination address is an IPv6 link-local address; and
performing the data transmission again by changing the used network interface from the default network interface to another network interface, in a case where it is determined by said determining that the destination address is an IPv6 link-local address and also where the data transmission using the default network interface has failed.

10. A method of controlling a communication apparatus that includes a plurality of network interfaces, comprising:
determining whether or not there is a network interface having an IP address in the same subnet as a destination IP address in the plurality of network interfaces;
selecting a network interface for use in performing data transmission from the plurality of network interfaces, in a case where it is determined by said determining that there is no network interface having an IP address in the same subnet as the destination IP address in the plurality of network interfaces;
performing data transmission using the network interface selected by said selecting; and
performing the data transmission again by changing the used network interface from the network interface selected by said selecting to another network interface, in a case where it is determined by said determining that there is no network interface having an IP address in the same subnet as the destination IP address in the plurality of network interfaces and also where the data transmission has failed.

11. A non-transitory computer-readable storage medium storing a computer-executable program for executing a method of controlling a communication apparatus that includes a plurality of network interfaces, one of the plurality of network interfaces being set as a default network interface,
wherein the method comprises:
determining whether or not there is a network interface having an IP address in the same subnet as a destination IP address in the plurality of network interfaces;
performing data transmission using the default network interface, in a case where it is determined by said determining that there is no network interface having an IP address in the same subnet as the destination IP address in the plurality of network interfaces; and
performing the data transmission again by changing the used network interface from the default network interface to another network interface, in a case where it is determined by said determining that there is no network interface having an IP address in the same subnet as the destination IP address in the plurality of network interfaces and also where the data transmission using the default network interface has failed.

12. A non-transitory computer-readable storage medium storing a computer-executable program for executing a method of controlling a communication apparatus that includes a plurality of network interfaces, one of the plurality of network interfaces being set as a default network interface,
wherein the method comprises:
determining whether or not a destination address is an IPv6 link-local address;
performing data transmission using the default network interface, in a case where it is determined by said determining that the destination address is an IPv6 link-local address; and
performing the data transmission again by changing the used network interface from the default network interface to another network interface, in a case where it is determined by said determining that the destination address is an IPv6 link-local address and also where the data transmission using the default network interface has failed.

13. A non-transitory computer-readable storage medium storing a computer-executable program for executing a method of controlling a communication apparatus that includes a plurality of network interfaces,
wherein the method comprises:
determining whether or not there is a network interface having an IP address in the same subnet as a destination IP address in the plurality of network interfaces;
selecting a network interface for use in performing data transmission from the plurality of network interfaces, in a case where it is determined by said determining that there is no network interface having an IP address in the same subnet as the destination IP address in the plurality of network interfaces;
performing data transmission using the network interface selected by said selecting; and
performing the data transmission again by changing the used network interface from the network interface selected by said selecting to another network interface, in a case where it is determined by said determining that there is no network interface having an IP address in the same subnet as the destination IP address in the plurality of network interfaces and also where the data transmission has failed.
